(19) United States
(12) Patent Application Publication
(10) Pub. No.: US 2013/0081523 A1
(43) Pub. Date: Apr. 4, 2013

(54) MANIPULATION TOOL FOR BELLOWS

(71) Applicants: Douglas E. Jones, Lafayette, IN (US); Keith W. Mellencamp, Lafayette, IN (US); Catalin M. Tiru, Lafayette, IN (US)

(72) Inventors: Douglas E. Jones, Lafayette, IN (US); Keith W. Mellencamp, Lafayette, IN (US); Catalin M. Tiru, Lafayette, IN (US)

(73) Assignee: Caterpillar Inc., Peoria, IL (US)

(21) Appl. No.: 13/248,078

(22) Filed: Sep. 29, 2011

(51) Int. Cl. B25B 27/30

(52) U.S. Cl. 81/486

(57) ABSTRACT

A manipulation tool for bellows. The manipulation tool includes a first set of grip members having a first upper grip member and a first lower grip member, and a second set of grip members having a second upper grip member and a second lower grip member. A first arm assembly is connected to the first set of grip members for moving the first upper grip member with respect to the first lower grip member along a width of the bellows. A second arm assembly is connected to the second set of grip members for move the second upper grip member with respect to the second lower grip member along the width of the bellows. Further, an operating mechanism is associated with the first arm assembly and the second arm assembly for moving the first arm assembly with respect to the second arm assembly along a length of the bellows.

### TECHNICAL FIELD

The present disclosure relates to bellows and more particularly, to a manipulation tool for the bellows.

### BACKGROUND

A bellows is a device for delivering air or fluid in a controlled quantity to a controlled location. A bellows may be employed in a variety of applications, such as torque coupling and flexible joints in machine exhaust systems, and may help accommodate movement and vibration. Conventionally, bellows include a convoluted body portion having a first end portion and a second end portion. A bellows is axially expandable and contractible and may be installed within confined spaces, such as between two pipes.

Various tools may be employed for manipulation of the bellows. For example, U.S. Pat. No. 7,171,877 discloses a compression tool for handling, compressing, and installing a compressible component, such as a bellows.

### SUMMARY

In one aspect, the present disclosure provides a manipulation tool for bellows. The manipulation tool includes a first set of grip members having a first upper grip member and a first lower grip member. A first arm assembly is connected to the first set of grip members. The first arm assembly is configured to relatively move the first upper grip member with respect to the first lower grip member along a width of the bellows. The manipulation tool further includes a second set of grip members having a second upper grip member and a second lower grip member. A second arm assembly is connected to the second set of grip members. The second arm assembly is configured to relatively move the second upper grip member with respect to the second lower grip member along the width of the bellows. Further, an operating mechanism is associated with the first arm assembly and the second arm assembly. The operating mechanism is configured to move the first arm assembly with respect to the second arm assembly along a length of the bellows.

In another aspect, the present disclosure provides a manipulation tool for bellows which includes a first set of grip members having a first upper grip member and a first lower grip member. The manipulation tool further includes a second set of grip members having a second upper grip member and a second lower grip member. Further, a ratcheting mechanism is associated to the first set of grip members and the second set of grip members. The ratcheting mechanism is configured to selectively lock the first upper grip member with respect to the first lower grip member and the second upper grip member with respect to the second lower grip member along a width of the bellows.

In another aspect, the present disclosure provides a manipulation tool for bellows which includes a first set of grip members having a first upper grip member and a second upper grip member. The manipulation tool further includes a first operating mechanism connecting the first upper grip member to the second upper grip member. The first operating mechanism is configured to be operated for moving the first upper grip member with respect to the second upper grip member along a length of the bellows. A first arm assembly of the manipulation tool includes a first end portion connected to a handle member and a second end portion connected to the first operating mechanism. A second set of grip members of the manipulation tool includes a first lower grip member and a second lower grip member. A second operating mechanism of the manipulation tool connects a first lower grip member to a second lower grip member. The second operating mechanism is configured to be operated for moving the first lower grip member with respect to the second lower grip member along the length of the bellows. Further, a second arm assembly of the manipulation tool includes a first end portion connected to the handle member and a second end portion connected to the second operating mechanism.

Other features and aspects of this disclosure will be apparent from the following description and the accompanying drawings.

### BRIEF DESCRIPTION OF THE DRAWINGS

FIG. 1 is a perspective view of a manipulation tool engaged with a bellows, according to an embodiment of the present disclosure;

FIG. 2 is another perspective view of the manipulation tool of FIG. 1;

FIG. 3 is an exploded view of the manipulation tool of FIG. 1;

FIG. 4 is a perspective view of a manipulation tool, according to another embodiment of the present disclosure;

FIG. 5 is a perspective view of a manipulation tool, according to another embodiment of the present disclosure; and

FIG. 6 is a perspective view of a manipulation tool, according to another embodiment of the present disclosure.

### DETAILED DESCRIPTION

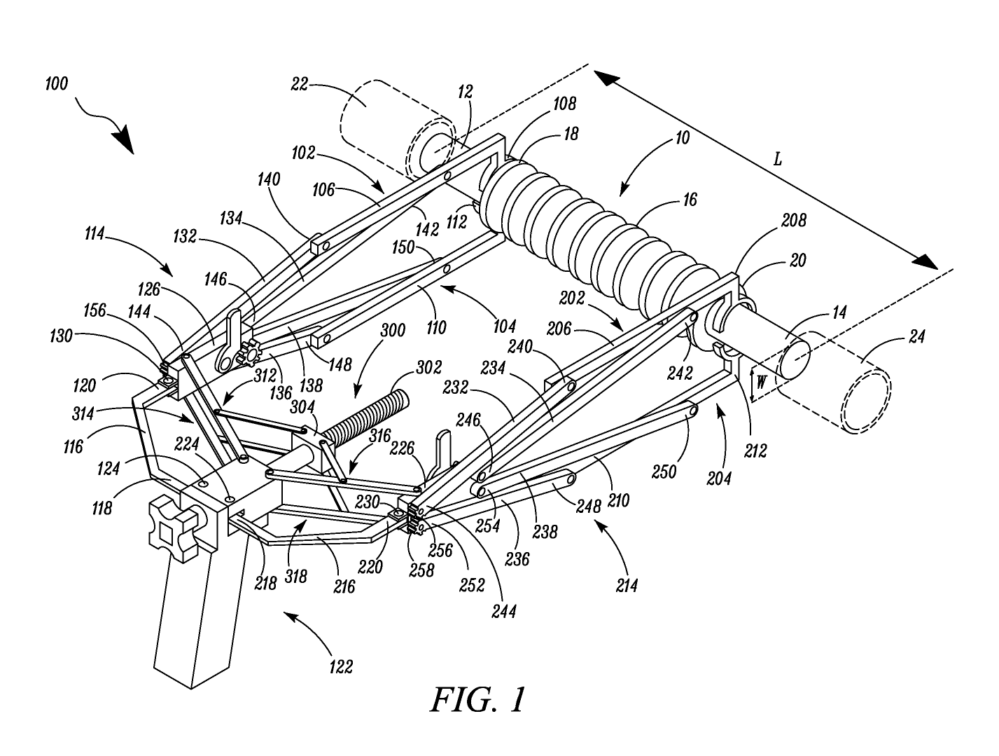

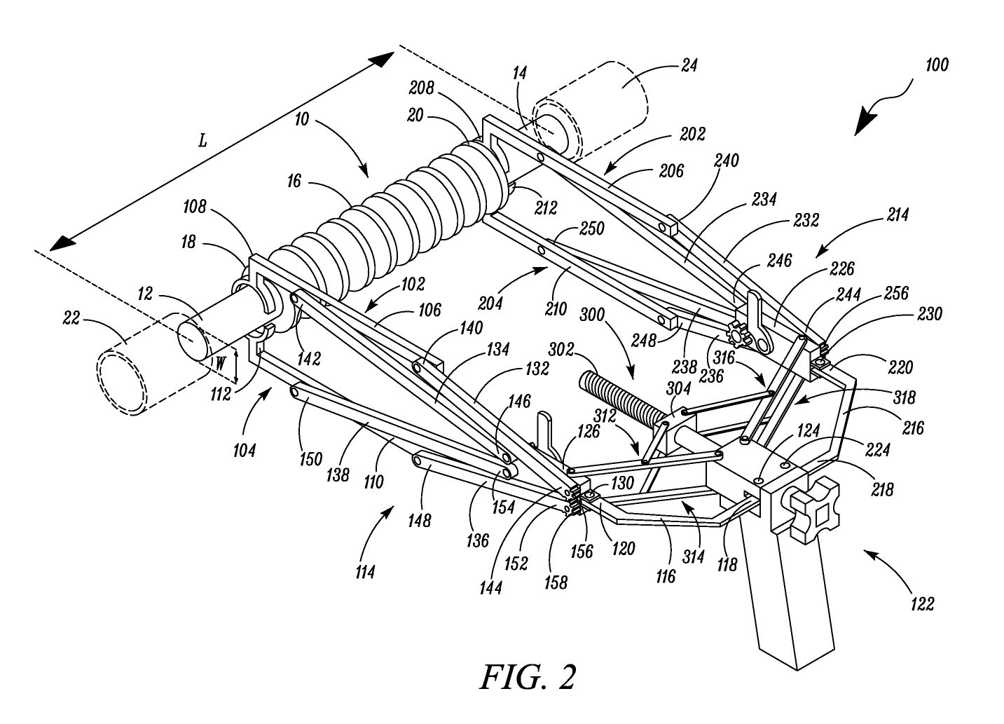

FIGS. 1 and 2 illustrate perspective views of a manipulation tool 100 with a bellows 10, according to an aspect of the present disclosure. In one embodiment, the bellows 10 may be installed within an exhaust system of an engine (not shown). In such an embodiment, the engine may be, but is not limited thereto, an internal combustion engine, a gasoline or diesel engine, a natural gas engine, propane gas engine, and the like. The engine may further include a number of cylinders arranged in any suitable configuration, for example, in-line arrangement, “V” arrangement, radial arrangement, or the like. The engine may be used to power any machine or other device, including on-highway trucks or vehicles, off-highway trucks or machines, earth moving equipment, generators, aerospace applications, locomotive applications, marine applications, pumps, stationary equipment, or other engine powered applications. Based on the application, the size of the engine may vary without deviating from the scope of the present disclosure.

The bellows 10 may provide a passage for flow of gases from the engine. The bellows 10 includes a first end portion 12, a second end portion 14 and a convoluted body portion 16 connecting the first end portion 12 and the second end portion 12, along a length L of the bellows 10. When the bellows 10 is installed in the exhaust system, the first end portion 12 is connected to a first exhaust pipe 22 receiving exhaust gases, e.g., from the internal combustion engine, whereas the second end portion 14 is connected to a second exhaust pipe 24. The convoluted body portion 16 of the bellows 10 is configured to be compressed and expanded due to the application of forces thereto.

According to exemplary embodiments herein the bellows 10 may be composed of rubber, plastic, metal or a combination thereof. Further, while the present exemplary embodiment is described mainly with respect to an exhaust system of an engine, other alternative embodiments may be possible in various areas based on application and design requirements.

In an embodiment of the present disclosure, the manipulation tool 100 includes a first set of grip members, such as a first upper grip member 102 and a first lower grip member 104. The first upper grip member 102 includes an elongated arm 106 and an arched portion 108. The arched portion 108 may be disposed at an end portion of the elongated arm 106. The arched portion 108 may be integral to the elongated arm 106. Alternatively, the arched portion 108 may be joined to the elongated arm 106 using any conventional joining means, such as welding, brazing, and the like.

The first lower grip member 104 also includes an elongated arm 110 and an arched portion 112. The arched portion 112 may be disposed at an end portion of the elongated arm 110. The arched portion 112 may be integral to the elongated arm 110. Alternatively, the arched portion 112 may be joined to the elongated arm 110 using any conventional joining means, such as welding, brazing, and the like. The arched portions 108 and 112 are configured to be removably engaged with a first portion 18 of the bellows 10. In an embodiment, the arched portions 108 and 112 circumferentially engage with the first portion 18 of the bellows 10, such that a diametrical distance between the arched portions 108 and 112 is approximately equal to a width W of the bellows 10. In alternative embodiments, where the bellows 10 may have square, rectangular or any other configuration, the arched portions 108 and 112 are configured to be engaged with the bellows 10 by adjusting distance between the arched portions 108 and 112. Further, the arched portions 108 and 112 may include a rubber coating to prevent damage to the bellows 10.

As illustrated in FIGS. 1 and 2, a first arm assembly 114 is connected to the first set of grip members 102, 104. The first arm assembly 114 is configured to relatively move the first upper grip member 102 with respect to the first lower grip member 104, along the width W of the bellows 10. In an embodiment, the first arm assembly 114 includes a first link 116 having a first end portion 118 and a second end portion 120. In an embodiment, the first link 116 has a bent, C-shaped configuration. The first end portion 118 is pivotally connected to a handle member 122 of the manipulation tool 100 using a fastener assembly 124. Alternatively, the first end portion 118 may be connected to the handle member 122 through any alternative pivot fastening mechanism which enables a pivotal movement of the first link 116 with respect to the handle member 122. In an embodiment of the present disclosure, the second end portion 120 may be connected to a first bracket 126 using a fastener 130, which enables pivotal movement of the first link 116 with respect to the first bracket 126.

The first arm assembly 114 further includes a first set of upper connecting links 132, 134, and a first set of lower connecting links 136, 138. First end portions 140, 142 of the first set of upper connecting links 132, 134 are pivotally connected to the elongated arm 106 of the first upper grip member 102 at connection points, using a fastener, similar to the fastener 130, such that the connection points may be spaced apart on the elongated arm 106. Second end portions 144, 146 of the first set of upper connecting links 132, 134 are pivotally connected to the first bracket 126. Further, first end portions 148, 150 of the first set of lower connecting links 136, 138 are pivotally connected to the elongated arm 110 of the first lower grip member 104 at spaced apart connection points, using fasteners, similar to the fastener 130. Second end portions 152, 154 of the first set of lower connecting links 136, 138 are pivotally connected to the first bracket 126.

As shown in FIG. 1, the second end portion 144 of the upper connecting link 132 includes a geared portion 156. Similarly, the second end portion 152 of the lower connecting link 136 includes a geared portion 158. The geared portion 156 meshes with the geared portion 158 such that movement in the upper connecting link 132 causes equivalent movement in the lower connecting link 136 and vice versa.

The manipulation tool 100 further includes a second set of grip members, such as a second upper grip member 202 and a second lower grip member 204. The second upper grip member 202 includes an elongated arm 206 and an arched portion 208. The arched portion 208 may be disposed at an end portion of the elongated arm 206. The arched portion 208 may be integral to the elongated arm 206. Alternatively, the arched portion 208 may be joined to the elongated arm 206 using any conventional joining means, such as welding, brazing, and the like.

The second lower grip member 204 also includes an elongated arm 210 and an arched portion 212. The arched portion 212 may be disposed at an end portion of the elongated arm 210. The arched portion 212 may be integral to the elongated arm 210. Alternatively, the arched portion 212 may be joined to the elongated arm 210 using any conventional joining means, such as welding, brazing, and the like. The arched portions 208 and 212 are configured to be removable engaged with a second portion 20 of the bellows 10. In an embodiment, the arched portions 208 and 212 circumferentially engage with the second portion 20 of the bellows 10, such that a diametrical distance between the arched portions 208 and 212 is approximately equal to the width W of the bellows 10. In alternative embodiments, where the bellows 10 may have square, rectangular or any other configuration, the arched portions 208 and 212 are configured to be engaged with the bellows 10 by adjusting distance between the arched portions 208 and 212 according to the width W of the bellows 10. Further, the arched portions 208 and 212 include a rubber coating to prevent damage to the bellows 10.

A second arm assembly 214 is connected to the second set of grip members 202, 204. The second arm assembly 214 is configured to relatively move the second upper grip member 202 with respect to the second lower grip member 204, along the width W of the bellows 10. In an embodiment, the second arm assembly 214 includes a second link 216 having a first end portion 218 and a second end portion 220. In an embodiment, the second link 216 has a bent, C-shaped configuration. The first end portion 218 of the second link 216 is pivotally connected to the handle member 122 of the manipulation tool 100 using a fastener assembly 224. Alternatively, the first end portion 218 may be connected to the handle member 122 through any alternative pivot fastening mechanism which enables a pivotal movement of the second link 216 with respect to the handle member 122. The second end portion 220 of the second link 216 is connected to a second bracket 226 using a fastener 230, which enables pivotal movement of the second link 216 with respect to the second bracket 226.

The second arm assembly 214 further includes a second set of upper connecting links 232, 234 and a second set of lower connecting links 236, 238. First end portions 240, 242 of the second set of upper connecting links 232, 234 are pivotally connected to the elongated arm 206 of the second upper grip member 202 at connection points, using fasteners, similar to the fastener 230, such that the connection points may be spaced apart on the elongated arm 206. Second end portions 244, 246 of the second set of upper connecting links 232, 234 are pivotally connected to the second bracket 226. Further, first end portions 248, 250 of the second set of lower connecting links 236, 238 are pivotally connected to the elongated arm 220 of the second lower grip member 204 at spaced apart connection points, using fasteners, similar to the fastener 230. Second end portions 252, 254 of the second set of lower connecting links 236, 238 are pivotally connected to the second bracket 226.

The second end portion 244 of the upper connecting link 232 includes a geared portion 256. Similarly, the second end portion 252 of the lower connecting link 236 includes a geared portion 258. The geared portion 256 meshes with the geared portion 258 such that movement in the upper connecting link 232 causes equivalent movement in the lower connecting link 236 and vice versa.

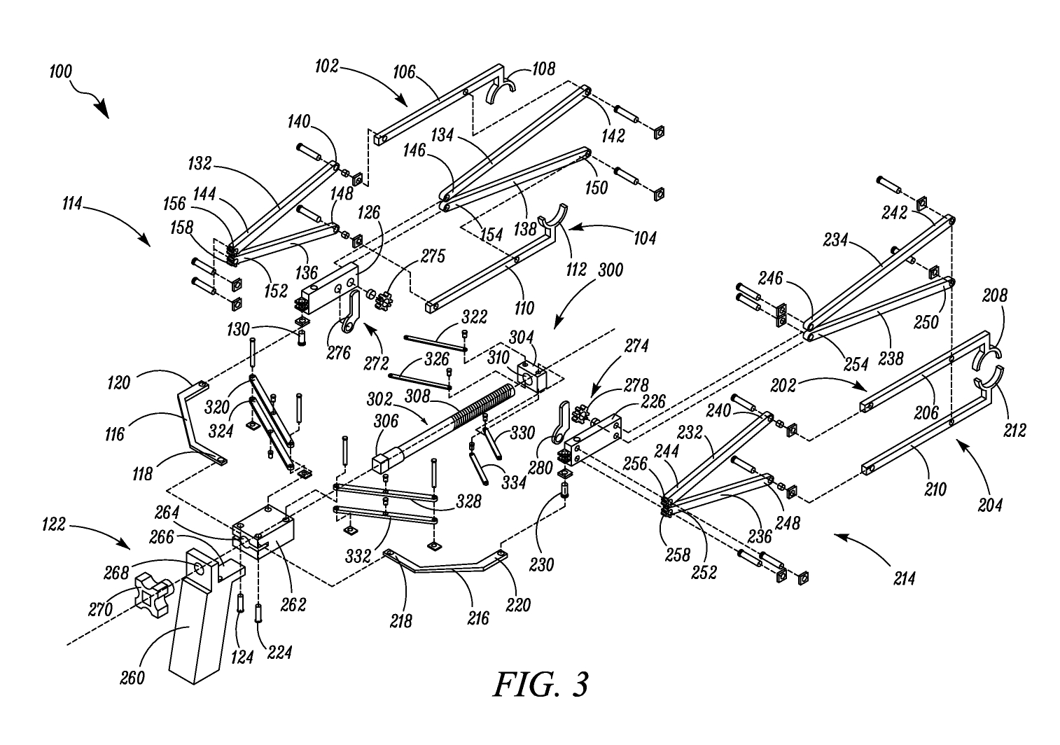

As shown in FIG. 3, the first bracket 126 and the second bracket 226 carry a ratcheting mechanism 272 and a ratcheting mechanism 274, respectively. The ratcheting mechanism 272 includes a toothed gear 275 connected to the first bracket 126. The toothed gear 275 may be connected to the first bracket 126 such that rotation of the toothed gear 275 may cause equal rotation to at least one of the first set of lower connecting links 136, 138. A pawl 276 of the ratcheting mechanism 272, carried by the first bracket 126, is spring biased towards the toothed gear 275. The pawl 276 resists movement of the toothed gear 275. The pawl 276 is configured to be displaced against the action of spring, for enabling movement of the toothed gear 275.

The ratcheting mechanism 274 includes a toothed gear 278 connected to the second bracket 226. The toothed gear 278 may be connected to the second bracket 226 such that rotation of the toothed gear 278 may cause equal rotation to at least one of the second set of lower connecting links 236, 238. A pawl 280 of the ratcheting mechanism 274, carried by the second bracket 226, is spring biased towards the toothed gear 278. The pawl 280 resists movement of the toothed gear 278. The pawl 280 is configured to be displaced against the action of spring, for enabling movement of the toothed gear 278.

The manipulation tool 100 further includes an operating mechanism 300 associated with the first arm assembly 114 and the second arm assembly 214. In an alternative embodiment, the operating mechanism 300 may be associated with one of the first arm assembly 114 and the second arm assembly 214. In an embodiment, the operating mechanism 300 may be configured to move the first arm assembly 114 with respect to the second arm assembly 214 along the length L of the bellows 10.

As illustrated in FIGS. 1 to 3, the operating mechanism 300 includes an elongated threaded member 302 and a sliding member 304. The elongated threaded member 302 includes a square portion 306 connected to a threaded shaft portion 308. The sliding member 304 may be engaged with the threaded shaft portion 308 of the elongated threaded member 302. In an embodiment, an internal threaded hole 310 of the sliding member 304 is engaged with the threaded shaft portion 308. It may here by apparent to those skilled in the art that, the sliding member 304 may move on the threaded shaft portion 308, with the rotation of elongated threaded member 302. In an embodiment, a movement limiting locknut (not shown) may be provided on the threaded shaft portion 308 to restrict movement of the sliding member 304 beyond a predetermined point. The operating mechanism 300 further includes an intermediate linkage having first members 312, 314 and second members 316, 318. The first member 312 includes a link 320 hingedly connected to the handle member 122 and the first bracket 126. Similarly, the first member 314 of the intermediate linkage, includes a link 324 hingedly connected to the handle member 122 and the first bracket 126. The intermediate linkage further include a link 322 which is hingedly connected to the link 320 and the sliding member 304 and a link 326 is hingedly connected to the link 324 and the sliding member 304.

The second member 316 includes a link 328 hingedly connected to the handle member 122 and the second bracket 226. A link 330 is hingedly connected to the link 328 and the sliding member 304. Further, the second member 316 includes a link 332 hingedly connected to the handle member 122 and the second bracket 226. A link 334 is hingedly connected to the link 232 and the sliding member 304.

In an embodiment, the handle member 122 includes a gripping portion 260 and a top tab 262 having a through-hole 264. The top tab 262 is configured to be attached to a top portion 266 of the griping portion 260 through fasteners, such that a hole 268 on the top portion 266 of the gripping portion 260 is in alignment with the through-hole 264 of the top tab 262. The elongated threaded member 302 is configured to be received within the through-hole 264 and the hole 268 such that the square portion 306 projects from one side of the handle member 122 while the threaded shaft portion 308 projects from the other side. A knob 270 may be engaged with the square portion 308 of the elongated threaded member 302.

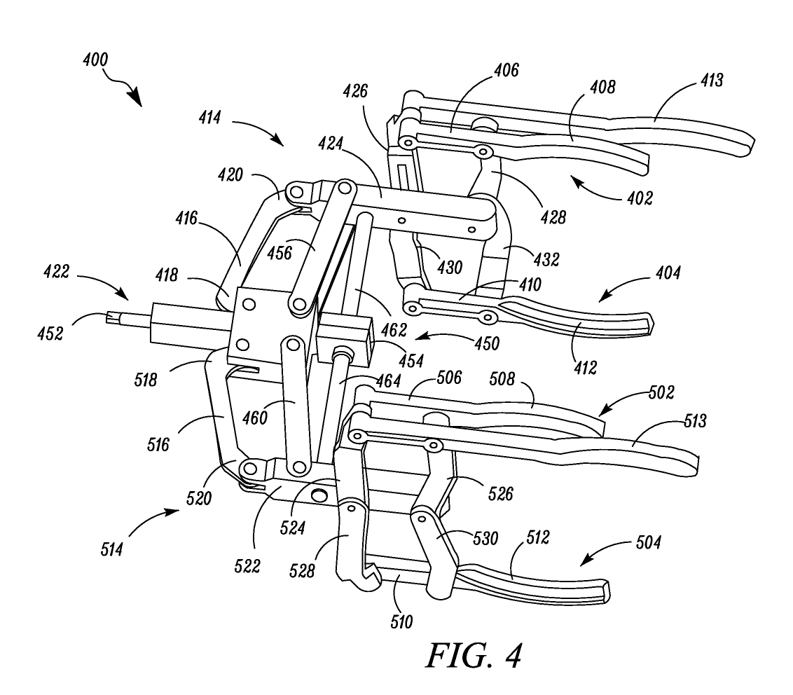

Referring now to FIG. 4, which illustrates a manipulation tool 400, according to another embodiment of the present disclosure. The manipulation tool 400 includes a first set of grip members, such as a first upper grip member 402 and a first lower grip member 404. The first upper grip member 402 includes an elongated arm 406 and an arched portion 408. The arched portion 408 may be disposed at an end portion of the elongated arm 406. The first lower grip member 404 also includes an elongated arm 410 and an arched portion 412. The arched portion 412 may be disposed at an end portion of the elongated arm 410. Further, the first set of grip members may include one or more removable grip members such as a first upper removable grip member 413.

The arched portions 408 and 412 are configured to be removably engaged with the first portion 18 of the bellows 10 (see FIG. 1). In an embodiment, the arched portions 408 and 412 circumferentially engage with the first portion 18 of the bellows 10, such that a diametrical distance between the arched portions 408 and 412 is approximately equal to the width W of the bellows 10. In an alternative embodiment, arched portion of the one or more removable grip members such as the first upper removable grip member 413 may engage with the bellows 10.

A first arm assembly 414 is connected to the first set of grip members 402, 404. The first arm assembly 414 is also connected to the first removable grip member 413. The first arm assembly 414 is configured to relatively move the first upper grip member 402 with respect to the first lower grip member 404, along the width W of the bellows 10. In an embodiment, the first arm assembly 414 includes a first link 416 having a first end portion 418 and a second end portion 420. The first end portion 418 is pivotally connected to a portion of a handle member 422 of the manipulation tool 400. The second end portion 420 may be connected to a first bracket 424. The first arm assembly 414 further includes a first set of upper connecting links 426, 428, and a first set of lower connecting links 430, 432. The first set of upper connecting links 426, 428 connect the first bracket 424 to the first upper grip member 402. The first set of lower connecting links 430, 432 connect the first bracket 424 to the first lower grip member 404.

The manipulation tool 400 further includes a second set of grip members, such as a second upper grip member 502 and a second lower grip member 504. The second upper grip member 502 includes an elongated arm 506 and an arched portion 508. The arched portion 508 may be disposed at an end portion of the elongated arm 506. The second lower grip member 504 also includes an elongated arm 510 and an arched portion 512. The arched portion 512 may be disposed at an end portion of the elongated arm 510. Further, the second set of grip members may also include one or more removable grip members such as a second upper removable grip member 513.

The arched portions 508 and 512 are configured to be removably engaged with the second portion 20 of the bellows 10. In an embodiment, the arched portions 508 and 512 circumferentially engage with the second portion 20 of the bellows 10, such that a diametrical distance between the arched portions 508 and 512 is approximately equal to the width W of the bellows 10 (see FIG. 1). In an alternative embodiment, arched portion of the one or more removable grip members such as the second upper removable grip member 513 may engage with the bellows 10.

A second arm assembly 514 is connected to the second set of grip members 502, 504. The second arm assembly 514 is configured to relatively move the second upper grip member 502 with respect to the second lower grip member 504, along the width W of the bellows 10. In an embodiment, the second arm assembly 514 includes a second link 516 having a first end portion 518 and a second end portion 520. The first end portion 518 of the second link 516 is pivotally connected to the handle member 422 of the manipulation tool 400. The second end portion 520 of the second link 516 is connected to a second bracket 522. The second arm assembly 514 further includes a second set of upper connecting links 524, 526 and a second set of lower connecting links 528,530. The second set of upper connecting links 524, 526 connect the second bracket 522 to the second upper grip member 502. The second set of lower connecting links 528, 530 connect the second bracket 522 to the second lower grip member 504.

The manipulation tool 400 further includes an operating mechanism 450 associated with the first arm assembly 414 and the second arm assembly 514. In an embodiment, the operating mechanism 450 may be configured to move the first arm assembly 414 with respect to the second arm assembly 514 along the length L of the bellows 10.

The operating mechanism 450 includes an elongated member 452 and a sliding member 454. The sliding member 454 may be threadably engaged with the elongated member 452. It may here by apparent to those skilled in the art that, the sliding member 454 may move on the elongated member 452, with the rotation thereof. The operating mechanism 450 further includes an intermediate linkage having a first member 456 and a second member 460. The first member 456 is hingedly connected to the handle member 422 and the first bracket 424. A threaded shaft 462 is connected to the sliding member 454 and the first bracket 424. The second member 460 is hingedly connected to the handle member 422 and the second bracket 526. A threaded shaft 464 is connected to the sliding member and the second bracket 526.

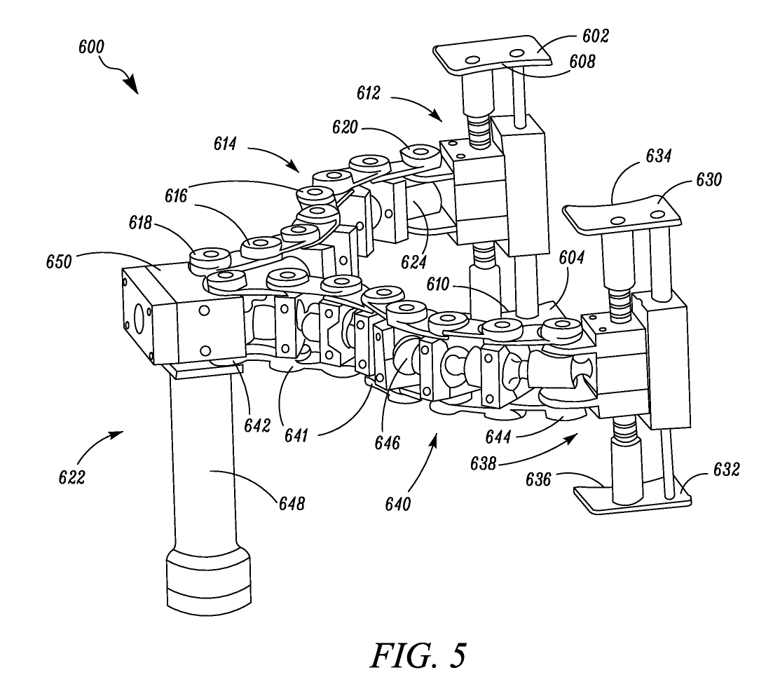

Referring now to FIG. 5, which illustrates a manipulation tool 600, according to another embodiment of the present disclosure. The manipulation tool 600 includes a first set of grip members, such as a first upper grip member 602 and a second upper grip member 604. The first upper grip member 602 and the second upper grip member 604 include arched portions 608 and 610, respectively. The arched portions 608 and 610 are configured to be removably engaged with parts of the first portion 18 and the second portion 20 of the bellows 10 (shown in FIG. 2). A first operating mechanism 612 connects the first upper grip member 602 and the second upper grip member 604. The first operating mechanism 612 is configured to be operated to move the first upper grip member 602 with respect to the second upper grip member 604 along the length “L” of the bellows 10.

A first arm assembly 614 is operatively connected to the first operating mechanism 612. Particularly, the first arm assembly 614 may be formed of a plurality of linkages 616 and includes a first end portion 618 and a second end portion 620. The first end portion 618 is pivotally connected to a handle member 622 of the manipulation tool 600. The second end portion 620 may be connected to the first operating mechanism 612. The first arm assembly 614 further includes a series of universal joints 624, carried by the plurality of linkages 616, for selectively transmitting torque to the first operating mechanism 612. In an embodiment, the torque transmitted by the series of universal joints 624 may operate the first operating mechanism 612.

The manipulation tool 600 further includes a second set of grip members, such as a first lower grip member 630 and a second lower grip member 632. The first lower grip member 630 and a second lower grip member 632 include arched portions 634 and 636, respectively. The arched portions 634 and 636 are configured to be removable engaged with parts of the first portion 18 and the second portion 20 of the bellows 10. A second operative mechanism 638 connects the first lower grip member 630 and the second lower grip member 632. The second operative mechanism 638 is configured to be operated to move the first lower grip member 630 with respect to the second lower grip member 632 along the length “L” of the bellows 10.

A second arm assembly 640 is operatively connected to the second operating mechanism 638. Particularly, the second arm assembly 640 may be formed of a plurality of linkages 641 and includes a first end portion 642 and a second end portion 644. The first end portion 642 is pivotally connected to the handle member 622 of the manipulation tool 600. The second end portion 644 is connected to the second operating mechanism 638. The second arm assembly 640 further includes a series of universal joints 646, carried by the plurality of linkages 641, for selectively transmitting torque to the second operating mechanism 638. In an embodiment, the torque transmitted by the series of universal joints 646 may operate the second operating mechanism 638.

In an embodiment, the handle member 622 includes a gripping portion 648 and a top tab 650. The top tab 650 connected to the first end portion 618, and 642 of the first arm assembly 614 and the second arm assembly 640 such that the first arm assembly 614 and the second arm assembly 640 may move with respect to each other along the width “W” of the bellows. The top tab 650 further includes a drive system (not shown), connected to the series of universal joints 624,646. The drive system may be operated by a mechanical tool, such as a nut runner to provide torque to the series of universal joints 624,646.

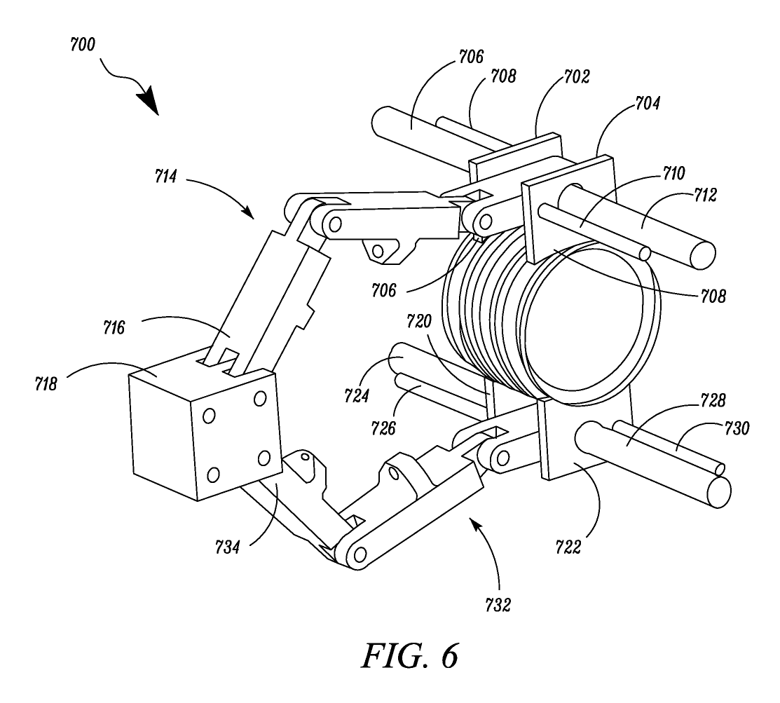

Referring now to FIG. 6, which illustrates a manipulation tool 700, according to yet another embodiment of the present disclosure. The manipulation tool 700 includes a first set of grip members, such as a first upper grip member 702 and a second upper grip member 704. A first upper pair of shafts 706, 708 is connected to the first upper grip member 702, such that the first upper grip member 702 may move on the first upper pair of shafts 706, 708 along the length L of the bellows 10. A second upper pair of shafts 710, 712 is connected to the second upper grip member 704, such that the second upper grip member 704 may move on the second upper pair of shafts 710, 712 along the length L of the bellows 10.

A first arm assembly 714 is operatively coupled to the first set of grip members 702, 704 at a junction of the first upper pair of shafts 706, 708 and the second upper pair of shafts 710, 712. An opposite end 716 of the first arm assembly 714 is hingedly connected to a holding member 718. The hinged connection of the first arm assembly 714 enables movement of the first arm assembly 714 along the width W of the bellows 10. In an embodiment, a flexible wire (not shown) may extend from the holding member 718 and pass through the first arm assembly 714 up to the first upper grip member 702 and the second upper grip member 704. The flexible wire may be pulled to alter an orientation of the first upper grip member 702 and the second upper grip member 704 with respect to the first arm assembly 714.

The manipulation tool 700 includes a second set of grip members, such as a first lower grip member 720 and a second lower grip member 722. A first lower pair of shafts 724, 726 is connected to the first lower grip member 720, such that the first lower grip member 720 may move on the first lower pair of shafts 724, 726 along the length L of the bellows 10. A second lower pair of shafts 728, 730 is connected to the second lower grip member 722, such that the second lower grip member 722 may move on the second lower pair of shafts 728, 730 along the length L of the bellows 10.

A second arm assembly 732 is operatively coupled to the second set of grip members, 720, 722 at a junction of the first lower pair of shafts 724, 726 and the second lower pair of shafts 728, 730. An opposite end 734 of the second arm assembly 732 is hingedly connected to the holding member 718. The hinged connection of the second arm assembly 732 enables movement of the second arm assembly 732 along width W of the bellows 10. In an embodiment, a flexible wire (not shown) may extend from the holding member 718 and pass through the second arm assembly 732 up to the first lower grip member 720 and the second lower grip member 722. The flexible wire may be pulled to alter an orientation of the first lower grip member 720 and the second lower grip member 722 with respect to the second arm assembly 732.

### INDUSTRIAL APPLICABILITY

According to embodiments herein, the bellows 10 is axially expandable and contractible along the length L thereof. During the installation of the bellows 10 in the exhaust system, the bellows 10 is aligned with the first and the second exhaust pipes 22 and 24. When not under compression, the bellows 10 may be in an expanded state and have a length greater than or equal to a space between the first and the second exhaust pipes 22 and 24. To install the bellows 10 in the exhaust system, the bellows is typically compressed along the length L. Based on the application and design, the bellows may be of various sizes and shapes along the length and width.

According to embodiments herein, the manipulation tool 100 includes the first upper grip member 102 and the first lower grip member 104 which may engage with the first portion 18 of the bellows 10, having the width W. Particularly, the arched portions 108 and 112 of the first upper grip member 102 and the first lower grip member 104 circumferentially engage with the first portion 18, thereby avoid a likelihood of slippage of the bellows 10. The first lower grip member 104 is configured to be moved angularly with respect to the first upper grip member 102. Therefore, the first portions such as the first portion 18, of the bellows 10 of various sizes along the width may be grasped between the first upper grip member 102 and the first lower grip member 104.

Further, the geared portion 156 of the upper connecting link 132 is intermeshed with the geared portion 158 of the lower connecting link 136. Therefore, the tilting movement to the upper connecting link 132 causes equivalent and opposite tilting movement to the lower connecting link 136, which displaces the first upper grip member 102 linearly with respect to the first lower grip member 104 along the width W.

The ratcheting mechanism 272 includes the toothed gear 275 connected to the first bracket 126 such that the toothed gear 275 moves with the movement of the first set of lower connecting links 136, 138. The pawl 276 is, however, spring biased towards the toothed gear 275 to restrict any movement of the toothed gear 275, unless moved against the spring biasing force. The ratcheting mechanism 272 therefore restricts any inadvertent relative movement of the first arm assembly 114.

Similarly, the second upper grip member 202 and the second lower grip member 204 which may engage with the second portion 20 of the bellows 10, having the width W. Particularly, the arched portion 208 and the arched portion 212 of the second upper grip member 202 and the second lower grip member 204 circumferentially engage with the second portion 20, thereby reducing likelihood of slippage of the bellows 10. The second lower grip member 204 is configured to be moved angularly with respect to the second upper grip member 202. Therefore, the second portions such as the second portion 20, of the bellows 10 of various sizes along the widths may be grasped between the second upper grip member 202 and the second lower grip member 204.

According to an aspect of the disclosure, the width W of the first portion 18 may be equal to or different from the width W of the second portion 20. In an alternative embodiment, the first upper grip member 102 and the first lower grip member 104 may engage with the second portion 20 of the bellows 10. The second upper grip member 202 and the second lower grip member 204 may engage with the first portion 18 of the bellows 10.

The geared portion 256 of the upper connecting link 232 is intermeshed with the geared portion 258 of the lower connecting link 236. Therefore, the tilting movement to the upper connecting link 232 causes equivalent and opposite tilting movement to the lower connecting link 236, which displaces the second upper grip member 202 linearly with respect to the second lower grip member 204 along the width W.

The ratcheting mechanism 274 includes the toothed gear 278 connected to the second bracket 226 such that the toothed gear 278 moves with the movement of the second set of lower connecting links 236, 238. The pawl 280 is, however, spring biased towards the toothed gear 278 to restrict any movement of the toothed gear 278, unless moved against the spring biasing force. The ratcheting mechanism 274 therefore restricts any inadvertent relative movement of the second arm assembly 214. Further, the ratcheting mechanism 272 and 274 facilitate quick and convenient installation and removal of the manipulation tool 100 from the bellows 10.

During utilization of the manipulation tool 100, the first set of grip members 102, 104 is engaged with the with the first portion 18 of the bellows 10 and the second set of grip members 202, 204 is engaged with the second portion 20 of the bellows 10. Thereafter, the operating mechanism 300 is actuated. Particularly, the knob 270 may be rotated to rotate the elongated threaded member 302. The knob may be rotated manually. Alternatively, the knob 270 may be rotated by an electric drive, pneumatic drive or mechanical tool, such as a nut runner. The sliding member 304 translates on the elongated threaded member 302 with the rotation of the elongated threaded member 302. In an embodiment, a clockwise rotation of the elongated threaded member 302 translates the sliding member 304 in a direction away from the handle member 122 and an anti-clockwise rotation of the elongated threaded member 302 translates the sliding member 304 in a direction towards the handle member 122.

The movement of the sliding member 304 tilts the first members 312, 314. The tilting movement of the first members 312, 314 moves the first arm assembly 114 thereby moving the first set of grip members 102 and 104 along the length L of the bellows 10. Further, the movement of the sliding member 304 also tilts the second member 316, 318. The tilting movement of the second members 316, 318 moves the second arm assembly 214, thereby moving the second set of grip members 202 and 204 along the length L of the bellows 10. In an embodiment, the clockwise rotation of the elongated threaded member 302 results to move the first set of grip members 102 and 104 towards the second set of grip members 202 and 204 thereby compressing the bellows 10 engaged therewith. The locknut provided on the elongated threaded member 302 may prevent the movement of the sliding member 304 beyond predetermined point. The locknut may therefore prevent the bellows 10 from getting damaged due to over compression.

Similarly during operation of the manipulation tool 400, the elongated member 452 is rotated. The rotation of the elongated member 452 moves the sliding member 454 therealong. Further, the rotation of the elongated member 452 also moves the threaded shafts 462 and 464 to move the first arm assembly 414 with respect to the second arm assembly 514 along the length L of the bellows 10.

Moreover, the manipulation tool 100 may be manufactured of aluminum. Alternatively, the manipulation tool 100 may be manufactured of any other suitable material such as cast iron, or steel. Thus, the manipulation tool 100 according to an aspect of this disclosure is light weight, cost effective and easy to manufacture. Aspects of this disclosure may also be applied to other flexible tube elements such as the bellows 10. While certain embodiments have been described above, it will be understood that the embodiments described are by way of example only. Accordingly, the apparatus described herein should not be limited based on the described embodiments. Rather, the apparatus described herein should only be limited in light of the claims that follow when taken in conjunction with the above description and accompanying drawings.

What is claimed is:

1. A manipulation tool for bellows, the manipulation tool comprising:
a first set of grip members comprising a first upper grip member and a first lower grip member;
a first arm assembly connected to the first set of grip members, the first arm assembly configured to relatively move the first upper grip member with respect to the first lower grip member along a width of the bellows;
a second set of grip members comprising a second upper grip member and a second lower grip member;
a second arm assembly connected to the second set of grip members, the second arm assembly configured to relatively move the second upper grip member with respect to the second lower grip member along the width of the bellows; and
an operating mechanism associated with the first arm assembly and the second arm assembly, the operating mechanism configured to move the first arm assembly with respect to the second arm assembly along a length of the bellows.

2. The manipulation tool of claim 1, wherein the first arm assembly comprises:
a first link pivotally connected to a handle member;
a first bracket connected to the first link;
a first set of upper connecting links pivotally connected to the first bracket; and
a first set of lower connecting links pivotally connected to the first bracket, wherein the first set of upper connecting links is configured to move angularly with respect to the first set of lower connecting links.

3. The manipulation tool of claim 2, wherein the first bracket carries a ratcheting mechanism configured to selectively lock the first set of upper connecting links with respect to the first set of lower connecting links.

4. The manipulation tool of claim 3, wherein the first upper grip member is pivotally connected to the first set of upper connecting links and the first lower grip member is pivotally connected to the first set of lower connecting links.

5. The manipulation tool of claim 1, wherein the first upper grip member and the first lower grip member each comprises an arched portion having a rubber coating.

6. The manipulation tool of claim 1, wherein the second arm assembly comprising:
a second link pivotally connected to a handle member;
a second bracket connected to a second bent link;
a second set of upper connecting links pivotally connected to the second bracket; and
a second set of lower connecting links pivotally connected to the second bracket, wherein the second set of upper connecting links is configured to move angularly with respect to the second set of lower connecting links.

7. The manipulation tool of claim 6, wherein the second bracket carries a ratcheting mechanism configured to selectively lock the second set of upper connecting links with respect to the second set of lower connecting links.

8. The manipulation tool of claim 7, wherein the second upper grip member is pivotally connected to the second set of upper connecting links and the second lower grip member is pivotally connected to the second set of lower connecting links.

9. The manipulation tool of claim 1, wherein the second upper grip member and the second lower grip member each comprise an arched portion comprising a rubber coating.

10. The manipulation tool of claim 1, wherein the operating mechanism comprising:
an elongated threaded member disposed in a through-hole in a handle member;
a sliding member associated with the elongated threaded member; and
an intermediate linkage connecting the sliding member to at least one of the first arm assembly and the second arm assembly.

11. The manipulation tool of claim 10, wherein the elongated threaded member is configured to move the sliding member along the elongated threaded member, and wherein the movement of the sliding member moves the first arm assembly with respect to the second arm assembly along the length of the bellows.

12. A manipulation tool for bellows, the manipulation tool comprising:
a first set of grip members comprising a first upper grip member and a first lower grip member;
a second set of grip members comprising a second upper grip member and a second lower grip member; and
a ratcheting mechanism associated to the first set of grip members and the second set of grip members, the ratcheting mechanism configured to selectively lock the first upper grip member with respect to the first lower grip member and the second upper grip member with respect to the second lower grip member along a width of the bellows.

13. The manipulation tool of claim 12 further comprising a first arm assembly connected to the first set of grip members, the first arm assembly configured to relatively move the first upper grip member with respect to the first lower grip member along the width of the bellows.

14. The manipulation tool of claim 13, wherein the first arm assembly comprising:
a first link pivotally connected to a handle member;
a first bracket connected to the first link;
a first set of upper connecting links pivotally connected to the first bracket; and
a first set of lower connecting links pivotally connected to the first bracket, wherein the first set of upper connecting links is configured to move angularly with respect to the corresponding first set of lower connecting links.

15. The manipulation tool of claim 14, wherein the first upper grip member is pivotally connected to the first set of upper connecting links and the first lower grip member is pivotally connected to the first set of lower connecting links.

16. The manipulation tool of claim 13 further comprising a second arm assembly connected to the second set of grip members, the second arm assembly configured to relatively move the second upper grip member with respect to the second lower grip member along the width of the bellows.

17. The manipulation tool of claim 16, wherein the second arm assembly comprises:
a second link pivotally connected to a handle member;
a second bracket connected to the second link;
a second set of upper connecting links pivotally connected to the second bracket; and
a second set of lower connecting links pivotally connected to the second bracket, wherein the second set of upper connecting links configured to move angularly with respect to the corresponding second set of lower connecting links.

18. The manipulation tool of claim 17, wherein the second upper grip member is pivotally connected to the second set of upper connecting links and the second lower grip member is pivotally connected to the second set of lower connecting links.

19. The manipulation tool of claim 16 further comprises an operating mechanism associated with the first arm assembly and the second arm assembly, the operating mechanism configured to move the first arm assembly with respect to the second arm assembly along a length of the bellows.

20. A manipulation tool for bellows, the manipulation tool comprising:
a first set of grip members comprising a first upper grip member and a second upper grip member;
a first operating mechanism connecting the first upper grip member to the second upper grip member, the first operating mechanism configured to be operated for moving the first upper grip member with respect to the second upper grip member along a length of the bellows;
a first arm assembly having a first end portion connected to a handle member and a second end portion connected to the first operating mechanism;
a second set of grip members comprising a first lower grip member and a second lower grip member;
a second operating mechanism connecting to the first lower grip member to the second lower grip member, the second operating mechanism configured to be operated for moving the first lower grip member with respect to the second lower grip member along the length of the bellows; and
a second arm assembly comprising a first end portion connected to the handle member and a second end portion connected to the second operating mechanism.
